(19) United States
(12) Patent Application Publication
(10) Pub. No.: US 2007/0030794 A1
(43) Pub. Date: Feb. 8, 2007

(54) Record carrier for the optical storage and retrieval of information

(76) Inventors: Christopher Busch, Eindhoven (NL); Johannes Theordorus Andriaan Wilderbeek, Eindhoven (NL); Alexander Marc Van Der Lee, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/556,611

(22) PCT Filed: May 13, 2004
(86) PCT No.: PCT/IB04/50668

§ 371 Date: Nov. 15, 2005

(30) Foreign Application Priority Data
May 19, 2003 (EP) 03 101396.4

(51) Int. Cl. G11B 3/70

(52) U.S. Cl. 369/283

(57) ABSTRACT

The invention relates to a record carrier for the storage and retrieval of information, comprising: a substrate (1), an active layer (2) for retention of information, the active layer employing bit-position encoding for the storage and retrieval of information and an energy shielding layer for shielding the energy during writing of the information in the active layer. Preferably, the energy shielding layer comprises a patterned reflective mask layer (3) or a switchable mask layer. Preferably, the reflective mask layer comprises a material with a relatively high thermal conductivity. Preferably, the patterned reflective mask layer comprises a metal or a metal alloy, preferably comprising aluminum silver, gold or copper. Preferably, the switchable mask layer comprises a thermo-chromic layer and is substantially transparent during the retrieval of information from the active layer. According to the invention, the record carrier has a relatively high information density.

The invention relates to a record carrier for the optical storage and retrieval of information.

The information age has led to an explosion of information available to users. (Personal) computers are omnipresent and connected via a worldwide network of computer networks. The decreasing costs of storing information, and the increasing storage capacities of the same small device footprint, have been key enablers of this revolution. While current storage needs are being met, storage technologies continue to improve in order to keep pace with the rapidly increasing demand.

Record carriers for optical storage of the kind mentioned in the opening paragraph are well known in the art. However, both magnetic and conventional optical information storage technologies, where individual bits are stored as distinct magnetic or optical changes on the surface of a recording medium, are approaching physical limits beyond which individual bits may be too small and/or too difficult to store and/or to distinguish. Inter-pixel or inter-symbol interference is a phenomenon in which intensity at one particular pixel contaminates information at nearby pixels. Physically, this interference arises from the band-limit of the (optical) channel, originating from optical diffraction or from time-varying aberrations in the lens system.

Two-dimensional (2D) information storage offers the possibility of an increase in data rate as well as an increase in data density. During (parallel) readout, the increased cross-talk in the signal can be dealt with. However, the close proximity of the bits during writing of information requires measures to enable independent switching of the bits without significant cross-talk.

The invention has for its object to eliminate the above disadvantage wholly or partly. According to the invention, a record carrier for the optical storage and retrieval of information of the kind mentioned in the opening paragraph for this purpose comprises:

a substrate,

an active layer for retention of information, the active layer employing bit-position encoding for the storage and retrieval of information, and

an energy shielding layer for shielding the energy during writing of the information in the active layer.

In a conventional one-dimensional (optical) record carrier a single bit row is written along a spiral. In general, the track pitch is chosen large enough to reduce thermal cross talk between neighboring tracks to acceptable levels. In addition, a recording dye layer is or, alternatively, inorganic phase change layers are distributed homogeneously across the recording medium. In the case of dye layers, these layers may not be homogeneously across the recording medium due to the presence of, for example, a pre-groove structure influencing the dye thickness on-land and in-groove during spin-coating. Depending on the spin conditions, the contrast of recording material thickness on-land and in-groove can be substantial.

When information is stored (recorded or coded) in the record carrier, the spot size of the storage means (for example a laser beam) is, preferably, such that only the active layer at a desired bit position is activated or de-activated and that adjacent bit positions are (practically) not affected by the storing means. However, if the bit density is higher than the resolving power of the spot size of the storage means, unfavorable cross-talk between (adjacent) bit positions is introduced. The energy shielding layer according to the invention shields the energy upon writing information in the active layer virtually reducing the spot size of the storage means. The energy shielding layer enhances the effect of the (spot size of the) storage means at the location of the bit on which information is to be written while, at the same time, the energy shielding layer reduces the effect of the (spot size of the) recording means on the bits adjacent to the bit on which information is to be written. The effect of the energy shielding layer is that the spot size of the recording means is “virtually” restricted to the bit position to a size smaller than the physical size of the spot of the recording means. In this manner cross-talk between (adjacent) bit positions is largely reduced. Hence, a relatively high density of bit positions can be realized in the record carrier according to the invention.

An active layer in the present description and claims is understood to be a layer in which information can be stored (coded) and changed. “Information” in the present description and claims is understood to comprise information (for instance music or video images, etc.) which is stored on or retrieved from the record carrier, as well as other information or data which may be present on the record carrier like guiding information, information about copy protection, etc.

The record carrier according to the invention can be an optical disc, a compact disc (CD), a CD-ROM, a CD-R, a CD-RW, and a DVD, BD, optical memory cards, and similar products. In addition, the record carrier according to the invention can be a HDD or a magnetic card with optical assistance.

By providing the energy shielding layer, optical properties of the record carrier are (virtually) patterned. The energy shielding layer can be realized in various embodiments. An embodiment of the energy shielding layer is to provide a patterned mask in the energy shielding layer. Another embodiment of the energy shielding layer is to provide a switchable mask layer.

A preferred embodiment of the record carrier according to the invention is characterized in that the energy shielding layer comprises a patterned reflective mask layer. By using a patterned reflective mask layer provided on the active layer, bit positions which are closer together than the spot size of the recording means can be individually discerned without cross-talk. The patterned reflective mask layer enables an optical separation between bit positions which, in practice, is beyond the resolving power of the recording means. The patterned reflective mask layer enhances the effect of the (spot size of the) storage means at the location of the bit on which information is to be written while, at the same time, the patterned reflective mask layer reduces the effect of the (spot size of the) recording means on the bits adjacent to the bit on which information is to be written. In this manner cross-talk between (adjacent) bit positions is largely reduced.

Preferably, the patterned reflective mask layer comprises a material with a relatively high thermal conductivity. A patterned reflective mask layer comprising a material with a relatively high thermal conductivity acts as a heat-sink layer at the inter-bit parts of the active layer. The inter-bit parts of the active layer are cooled by the heat-sink.

Preferably, the patterned reflective mask layer comprises a metal or a metal alloy, preferably comprising aluminum silver, gold or copper. Metal, in particular aluminum is a suitable heat-sink material. In addition, it has favorable material properties. The chosen material should preferably exhibit inertness to oxidation. Suitable metal alloys are Au-alloys, Ag-alloys, Al-alloys. The thermal and optical properties of the recording stack (including mask and recording layer and possibly also other dielectric and metal layers) can be tuned by choosing the appropriate materials. In addition, the thicknesses of the reflective mask layer can be selected with favorable properties. For instance a thick metal reflective mask layer has a relatively high cooling capacity. In addition, the thickness of different layers can be tuned to form a (multilayer) interference stacks.

An alternative, preferred embodiment of the record carrier according to the invention is characterized in that the energy shielding layer comprises a switchable mask layer. During storing information in the active layer, the switchable mask layer is substantially transparent at the location of the bit position where information is to be stored while at the same time the switchable mask layer is substantially opaque at bit positions surrounding the bit position where information is to be stored. During storing information in the active layer at the location of the bit position where information is to be stored, the power of the spot of the recording means is increased above a pre-determined threshold rendering the switchable mask layer opaque (either absorbing or reflecting) at the location of the bit position where information is to be stored and at bit positions surrounding the bit position where information is to be stored. By having an even higher power of the spot of the recording means at the location of the bit position where information is to be stored, the switchable mask layer at the location of the bit position where information is to be stored becomes transparent again while at the same time the switchable mask layer remains substantially opaque at bit positions surrounding the bit position where information is to be stored.

The switchable mask layer enhances the effect of the (spot size of the) storage means at the location of the bit on which information is to be written while, at the same time, the switchable mask layer reduces the effect of the (spot size of the) recording means on the bits adjacent to the bit on which information is to be written. An additional advantage of the application of a switchable mask layer is that the blocking part of the switchable mask layer can be much larger than the distance to the nearest neighbors of bits. Yet another advantage of the switchable mask layer is that it is compatible with multi-layer storage (2 or more recording layers) which is relatively difficult to achieve with the non-switchable mask version.

A preferred embodiment of the record carrier according to the invention is characterized in that characterized in that the switchable mask layer is substantially transparent during the retrieval of information from the active layer. Only during storing information in the active layer at the location of the bit position where information is to be stored, the power of the spot of the recording means is increased above the pre-determined threshold rendering the switchable mask layer opaque. During retrieval of information the switchable mask layer is substantially transparent.

Preferably, the switchable mask layer comprises a thermo-chromic layer. Thermo-chromic materials exhibit temperature-dependent absorption or reflection characteristics at a given wavelength range. For instance, upon temperature increase, the absorption maximum can be shifted bathochromically (red-shift) or hypsochromically (blue-shift). In an alternative embodiment two different thermo-chromic materials having different temperature-dependent absorption or reflection characteristics are employed.

A boundary condition is the cyclicity (i.e. the number of time the thermo-chromic transition can be accomplished) of the reversible thermo-chromic effect that has to take place during every time information is stored in the active layer. In addition, the temperature difference needed to initiate the effect should be relatively low for reasons of power consumption and material stability. On the other hand, the thermo-chromic effect has to be above the operating temperature of the record carrier.

A further alternative, preferred embodiment of the record carrier according to the invention is characterized in that the energy shielding layer comprises a patterned reflective mask layer and a switchable mask layer.

Other advantageous embodiments and further developments are defined in the dependent claims.

The invention will now be explained in more detail with reference to a number of embodiments and accompanying drawing figures in which:

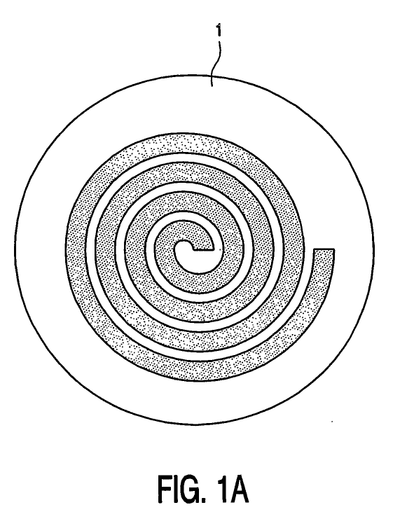

FIG. 1 shows a record carrier for optical storage and retrieval of information according to the invention;

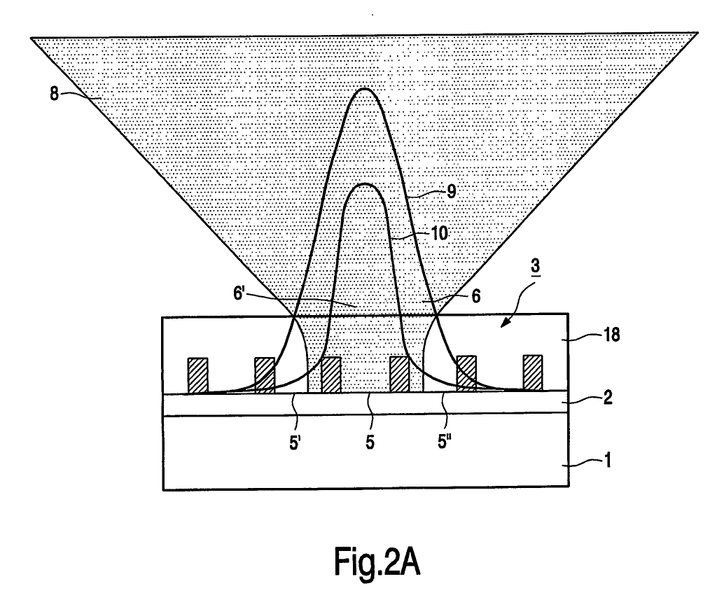

FIG. 2A shows a side view of an embodiment of the record carrier for optical storage and retrieval of information comprising a patterned reflective mask layer during storing of information in the active layer at a pre-selected bit position;

FIG. 2B shows a top view of the record carrier as shown in FIG. 2A;

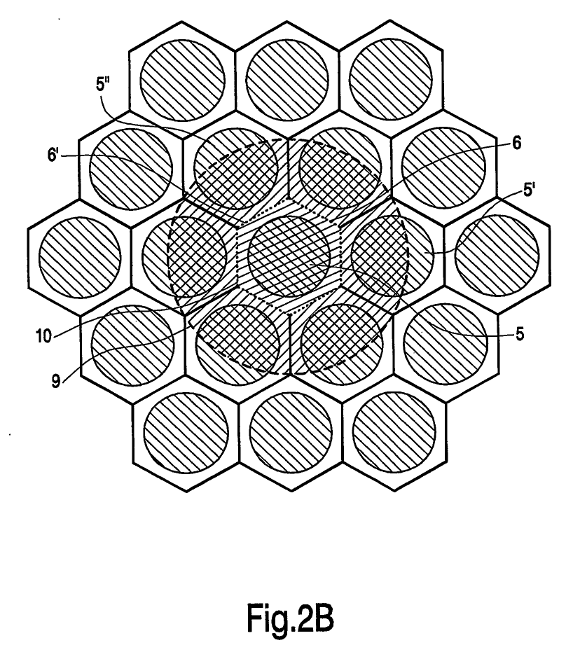

FIG. 3A shows a temperature profile of a record carrier comprising a thermo-chromic layer according to the invention;

FIG. 3B shows a transmission function of the thermo-chromic layer as shown in FIG. 2A as a function of temperature;

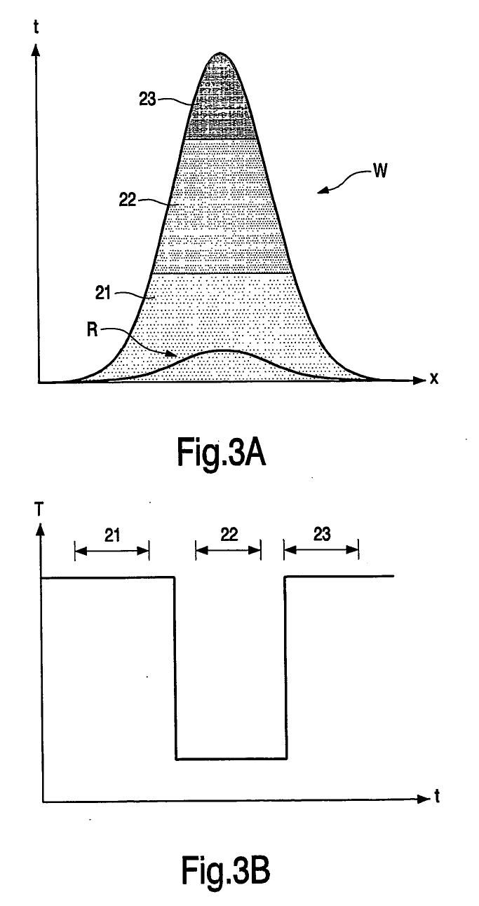

FIG. 4A shows side view of a record carrier comprising a thermo-chromic layer according to the invention during storing of information in the active layer at a pre-selected bit position,

FIG. 4B shows top view of the record carrier as shown in FIG. 4A;

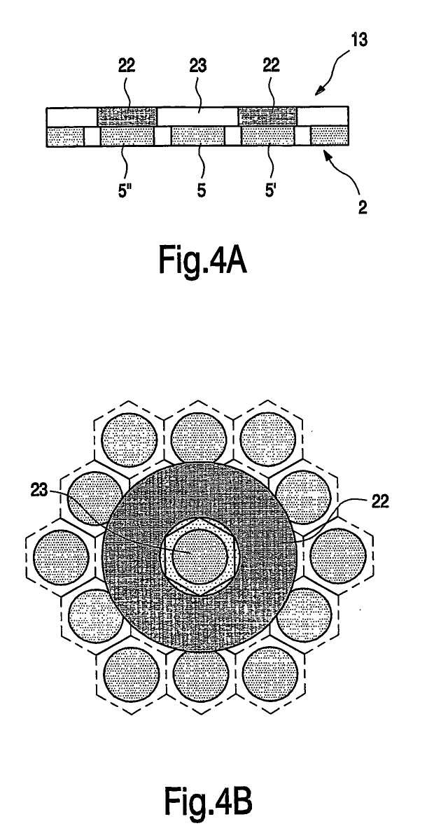

FIG. 5A shows side view of the record carrier as shown in FIG. 3A during reading of information from the active layer at a pre-selected bit position,

FIG. 5B shows top view of the record carrier as shown in FIG. 5A;

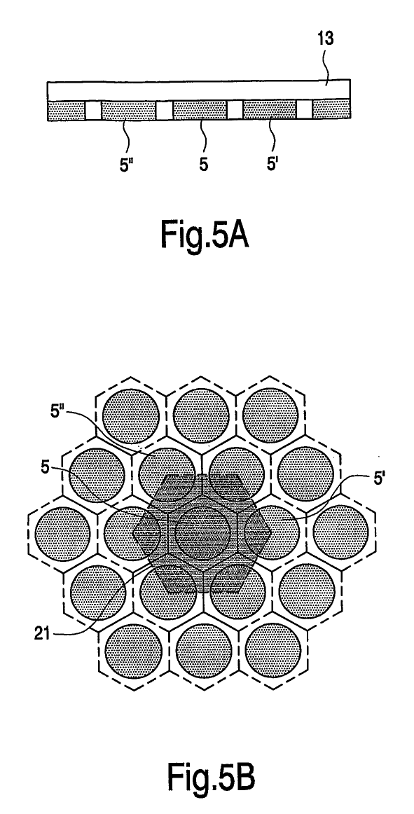

FIG. 6A shows the absorption characteristics as a function of wavelength for a bathochromic thermo-chromic layer;

FIG. 6B shows the absorption characteristics as a function of wavelength for a hyposochromic thermo-chromic layer;

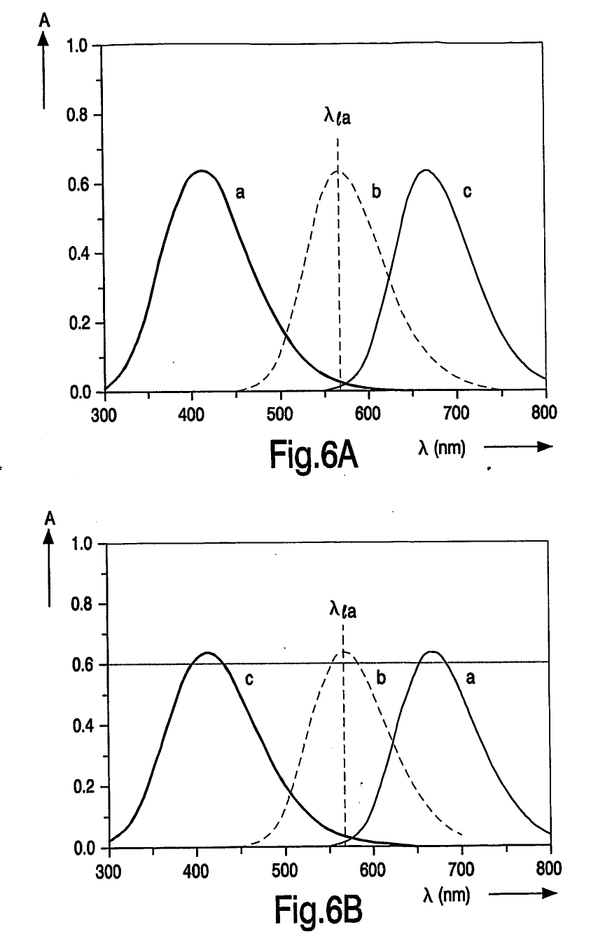

FIG. 7 shows the transmission characteristics as a function of wavelength for a cholesteric material, and

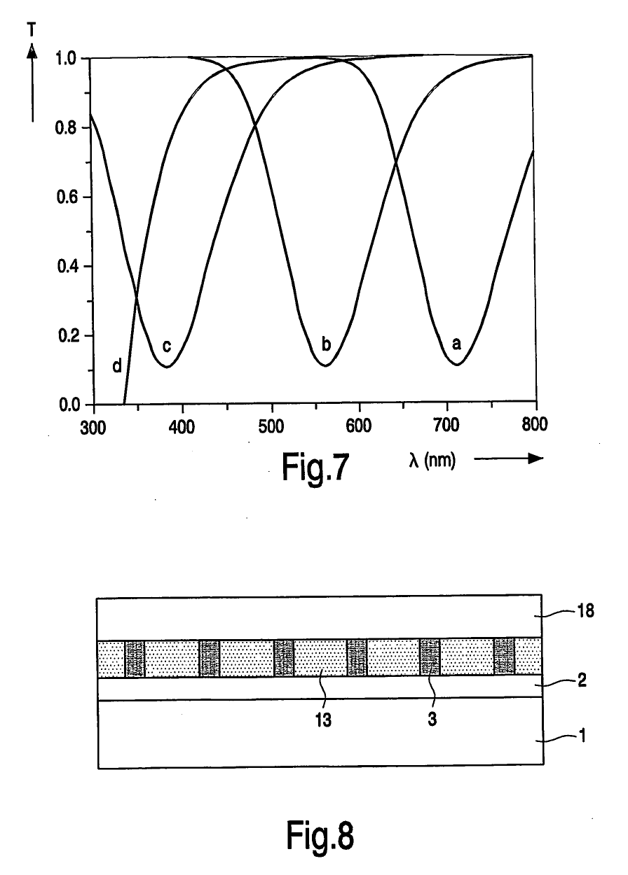

FIG. 8 shows an embodiment of the record carrier for optical storage and retrieval of information comprising a patterned reflective mask layer and a switchable mask layer according to the invention.

The Figures are purely diagrammatic and not drawn true to scale. Some dimensions are particularly strongly exaggerated for reasons of clarity. Equivalent components have been given the same reference numerals as much as possible in the Figures.

FIG. 1 shows very schematically a record carrier for optical storage and retrieval of information according to the invention. In FIG. 1 a substrate 1 is provided by a strip or track in the form of a spiral of possible bit positions. Upon storing and retrieving of information the spiral is followed by the storage or retrieval means, respectively.

FIG. 2A shows very schematically a side view of an embodiment of the record carrier for optical storage and retrieval of information comprising a patterned reflective mask layer 3 during storing of information in the active layer at a pre-selected bit position. FIG. 2B shows a top view of the record carrier as shown in FIG. 2A. The record carrier comprises a substrate 1. The substrate 1 is provided with an active layer 2 for retention of information. The active layer 2 employs bit-position encoding for the storage and retrieval of information.

Preferably, the active layer 2 is a recording dye layer (typical for a WORM recording medium). Preferably, such layers are deposited by conventional techniques such as spin coating, embossing, molding, (photo)lithography, micro-contact printing or vapor deposition. Alternatively, inorganic phase change layers may also be used as a WORM or re-writable recording medium. Preferably, the latter layers are deposited by sputtering.

Very schematically in FIG. 2A and 2B possible bit positions 5, 5′, 5″, . . . are indicated in the active layer 2. In the record carrier information is stored at and retrieved from these bit positions 5, 5′, 5″, . . .

In FIG. 2A an energy shielding layer for shielding the energy during writing of the information in the active layer 1 is provided on the active layer 2. In the example of FIG. 2A, the energy shielding layer is a patterned reflective mask layer 3 embedded in a transparent cover layer 18. The patterned reflective mask layer 3 comprises walls 6, 6′, . . . of a material with a relatively high thermal conductivity, preferably, a metal, preferably aluminum. The walls 6, 6′, . . . in FIG. 2A and 2B surround the possible bit positions 5, 5′, 5″, . . . In alternative embodiments, only part of the walls 6, 6′, . . . are provided.

When information is stored (recorded or coded) in the record carrier as shown in FIG. 2A and 2B, the spot size of the storage means (for example a laser beam) is, preferably, such that only the active layer at a desired bit position is activated or de-activated and that adjacent bit positions are (practically) not affected by the storing means. However, if the bit density is higher than the resolving power of the spot size of the storage means, unfavorable cross-talk between (adjacent) bit positions is introduced.

The light beam emitted by the storage means is schematically indicated by the light cone 8 in FIG. 2A. In addition, the intensity profile of the spot of the storage means is indicated in FIG. 2A with the curve 9; in FIG. 2B the intensity profile is indicated by the dotted circle with reference numeral 9. The thermal profile of the spot of the storage means is indicated in FIG. 2A is indicated by curve 10. The walls 6, 6′, . . . of the patterned reflective mask layer 3 form in the example of FIG. 2A and 2B a hexagonal structure on the active layer 2 of the record carrier. Correspondingly, the thermal profile is indicated in FIG. 2B by the dotted hexagon with reference numeral 10. The patterned reflective mask layer 3 shields the energy upon writing information in the active layer 2 by virtually reducing the spot size of the storage means. The effect of the patterned reflective mask layer is that the spot size is virtually limited to the size of the “central” bit with reference numeral 5 in FIG. 2A and 2B.

By using a patterned reflective mask layer 3 provided on the active layer 2, bit positions 5, 5′, 5″, . . . can be individually discerned without cross-talk. The patterned reflective mask layer 3 enables an optical separation between bit positions 5, 5′, 5″, . . . which, in practice, would be beyond the resolving power of the recording means. Hence, a relatively high density of bit positions 5, 5′, 5″, . . . can be realized in the record carrier according to the invention.

Although in FIG. 2A the patterned reflective mask layer 3 is shown on top of the active layer 2, the patterned reflective mask layer can also form an integral part of the recording stack.

FIG. 3A shows a temperature profile W during writing in the active layer of a record carrier comprising a thermo-chromic layer according to the invention as a function of the position x on the active layer 2. Correspondingly, FIG. 3B shows the transmission T as function of the temperature t during retrieval of information from in the active layer 2 of a record carrier comprising a thermo-chromic layer. As long as the power of the spot of the recording means is below a pre-determined first threshold (indicated by the area 21 in the temperature W in FIG. 3A and, correspondingly, in the transmission T in FIG. 3B), the switchable mask layer 13 is transparent.

During storing information in the active layer, the switchable mask layer 13 has to be substantially transparent at the location of the bit position 5 where information is to be stored while at the same time the switchable mask layer 13 is substantially opaque at bit positions 5′, 5″, . . . surrounding the bit position 5. During storing information in the active layer 2 at the location of the bit position 5, the power of the spot of the recording means is increased above a pre-determined first threshold (indicated by the area 22 in the temperature W in FIG. 3A and, correspondingly, in the transmission T in FIG. 3B) rendering the switchable mask layer 13 opaque (either absorbing or reflecting) at the location of the bit position 5 and at bit positions 5′, 5″, . . . surrounding the bit position 5. By further increasing the power of the spot of the recording means at the location of the bit position 5 above a pre-determined second threshold (indicated by the area 23 in the temperature W in FIG. 3A and, correspondingly, in the transmission T in FIG. 3B), the switchable mask layer 13 at the location of the bit position 5 becomes transparent again while at the same time the switchable mask layer 13 remains substantially opaque at bit positions 5′, 5″, . . . surrounding the bit position 5.

The switchable mask layer 13 enhances the effect of the (spot size of the) storage means at the location of the bit 5 on which information is to be written while, at the same time, the switchable mask layer 13 reduces the effect of the (spot size of the) recording means on the bits 5′, 5″, . . . adjacent to the bit 5 on which information is to be written. An additional advantage of the application of a switchable mask layer is that the blocking part of the switchable mask layer can be much larger than the distance to the nearest neighbors of bits.

FIG. 3A also shows a temperature profile R during reading from the active layer of a record carrier comprising a thermo-chromic layer according to the invention. During reading, the power of the spot of the recording means is well below the pre-determined first threshold (indicated by the area 21 in the temperature W in FIG. 3A and, correspondingly, in the transmission T in FIG. 3B), the switchable mask layer 13 being transparent.

FIG. 4A shows a side view of a record carrier comprising a thermo-chromic layer 13 according to the invention during storing of information in the active layer 2 at a pre-selected bit position 5. Correspondingly, FIG. 4B schematically shows a top view of the record carrier as shown in FIG. 4A. At the location of the bit position 5 the power of the spot of the recording means is above the pre-determined second threshold as described in FIG. 3A and 3B rendering the switchable mask layer 13 at the location of the bit position 5 transparent. The transparent area is indicated by the reference numeral 23 in FIG. 4A and 4B. In addition, the power of the spot of the recording means at the location of the bit positions 5′, 5″, . . . surrounding the bit position 5, is above the pre-determined first threshold and below the second threshold as described in FIG. 3A and 3B rendering the switchable mask layer 13 at the location of the bit position 5′, 5″, . . . opaque. The opaque area is indicated by the reference numeral 22 in FIG. 4A and 4B.

FIG. 5A schematically shows a side view of the record carrier as shown in FIG. 3A during reading of information from the active layer at a pre-selected bit position. Correspondingly, FIG. 5B schematically shows a top view of the record carrier as shown in FIG. 5A. During reading the power of the spot of the recording means is well below the pre-determined first threshold as described in FIG. 3A and 3B rendering the switchable mask layer 13 at the location of the bit positions 5, 5′, 5″, . . . transparent. The transparent area around bit position 5 is indicated by the reference numeral 21 in FIG. 5B.

FIG. 6A shows the absorption characteristics as a function of wavelength for a bathochromic thermo-chromic layer. In the example of FIG. 6A, the wavelength λ₁ₐ of the recording means is set to approximately 570 nm. The absorption characteristics of the employed materials for the thermo-chromic layer are chosen such that little or no absorption is experienced at ambient temperature (i.e. the temperature during read-out), e.g. the thermo-chromic layer shows an absorption maximum in the blue wavelength region (FIG. 6A, curve a). Due to the thermo-chromic behavior of the material, a red-shift is observed upon temperature increase (FIG. 6A, curve b), corresponding to the mask area 22 of FIG. 4A and 4B. Upon a further increase in temperature, the absorption of the thermo-chromic layer at the laser wavelength decreases again resulting from the continuing thermo-chromic behavior (FIG. 6A, curve c).

Instead of using a thermochromic red-shift, a similar situation can be obtained by using a thermochromic blue-shift. FIG. 6B shows the absorption characteristics as a function of wavelength for a hyposochromic thermo-chromic layer. In the example of FIG. 6B, the wavelength λ₁ₐ of the recording means is set to approximately 570 nm. The absorption characteristics of the employed materials for the thermo-chromic layer are chosen such that little or no absorption is experienced at ambient temperature (i.e. the temperature during read-out), e.g. the thermo-chromic layer shows an absorption maximum in the red wavelength region (FIG. 6B, curve a). Due to the thermo-chromic behavior of the material, a blue-shift is observed upon temperature increase (FIG. 6B, curve b), corresponding to the mask area 22 of FIG. 4A and 4B. Upon a further increase in temperature, the absorption of the thermo-chromic layer at the laser wavelength decreases again resulting from the continuing thermo-chromic behavior (FIG. 6B, curve c).

The depicted behavior in FIGS. 6A and 6B is fully reversible and cyclibility numbers exceeding several thousands have been reported. In the case of a WORM application, the effect has to occur only once or twice, decreasing the demands on the material.

The above-mentioned implementations of thermo-chromic layers are based on a single dye or on the use of a mixture of dyes, with a chemical constitution and mixture formulation tailored to the specific wavelength and absorption characteristics. Alternatively, a single dye or mixture of dyes may be employed that show(s) an initial thermo-chromic absorption effect (e.g. a red-shift or a blue-shift) with increasing temperature, followed by a hypochromic (intensity decrease) shift. Preferably, the hypochromic effect originates from the reversible dye-temperature interaction.

Preferably, the thermo-chromic layer comprises pure elongated pi-conjugated oligomers or polymers of pi-conjugated materials in a solid, semi-solid, or gel-type matrix of organic, preferably polymeric, inorganic or organic-inorganic hybrid nature, in particular having a concentration of pi-conjugated material between 1 and 100%. In elongated (π−)conjugated molecules or polymers the thermochromic effect is caused by the change in conformational freedom with temperature. At low temperatures the conformational freedom is limited and as a result the conjugated molecules have a relative planar geometry. With increasing temperature there is an increase in the conformational freedom and the geometry of the molecules is less planar. Consequently, the effective conjugation in the molecules decreases with increasing temperature, resulting in a blue-shift of the absorption band.

Preferably, the thermo-chromic layer comprises pH-sensitive dye molecules and colour developers. Many compounds are known that change their color (absorption spectrum) with a change in pH. Examples of such compounds are fluoran derivatives and crystal violet lactone. A thermo-chromic mixture can be obtained if these pH sensitive dyes are mixed with a color-developer and a solvent. For reversible thermo-chromic systems the color developers are generally weak acids. The pH sensitive dyes and the color developers are dissolved or mixed in a third compound, generally belonging to the class of alcohols or esters. The melting point of the third compound (solvent) determines the temperature at which the color change will occur. As the solvent melts or softens, the dye can react with the weak acid, resulting in a color change. Generally, the colored form can be frozen by rapid cooling, while the colorless dye is formed upon slow cooling.

Preferably, the thermo-chromic layer comprises a dye material in which the dye molecules can be aggregated depending on the temperature, in particular forming J-type aggregates or H-type aggregates. The formation of J-type aggregates will result in a red-shift of the absorption maximum while the formation of H-type aggregates will result in a blue-shift of the absorption maximum and a red-shift of the onset of absorption.

Preferably, the switchable mask layer comprises a liquid crystalline material, preferably a chiral nematic or a cholesteric liquid crystalline material. A chiral nematic phase or cholesteric phase can also be obtained by adding small amounts, typically 0.02-20% by weight of a chiral dopant to an otherwise non-cholesteric nematic material. Chiral nematic or cholesteric liquid crystals show a polarization-selective reflection provided the wavelength of the circularly polarized incoming light fulfills the reflection condition: λ− n̅·p

where λ is the wavelength of the reflected light, n̅ is the average refractive index of the liquid crystal, and p is the pitch length of the helix of the liquid crystal director. One handedness of the incoming circularly polarized light is absorbed and reflected, whereas the other handedness is transmitted, provided a monolithically aligned liquid crystal is used (e.g. having a Grandjean or fingerprint texture). FIG. 7 shows the transmission characteristics as a function of wavelength for a typical cholesteric material. In the example of the FIG. 7 curves a-c, the position of the absorption spectrum shifts as a function of temperature, due to the temperature-dependent pitch variation of the cholesteric helix. Hence, only for a distinct temperature window selective reflection of the circularly polarized incoming laser wavelength will occur. Optionally, the temperature may increase beyond the cholesteric-to-isotropic transition. In the situation of FIG. 7, no absorption and/or reflection occurs if the used laser wavelength is in the visible range (see FIG. 7, curve d). The choice of the employed cholesteric material depends on the used laser wavelength, the required temperature window and the required refractive indices of the liquid crystalline materials and its surroundings. The transmission-layer thickness relationship and the switching kinetics of these materials are important parameters of switchable mask layer comprising a liquid crystalline material. In particular, for a substantial absorption and reflection to occur, at least 10 pitch lengths are preferably required. This implies that relatively thick layers may be are required.

Although in FIGS. 4A and 5A the switchable mask layers 13 is shown on top of the active layer 2, the switchable mask layer 13 can also form an integral part of the active layer.

FIG. 8 schematically shows an embodiment of the record carrier for optical storage and retrieval of information comprising a patterned reflective mask layer 3 and a switchable mask layer 13 according to the invention on a substrate 1 provided with an active layer 2.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A record carrier for the optical storage and retrieval of information, the record carrier comprising:
a substrate (1),
an active layer (2) for retention of information, the active layer (2) employing bit-position encoding for the storage and retrieval of the information, and
an energy shielding layer for shielding the energy during writing of the information in the active layer (2).

2. A record carrier as claimed in claim 1, characterized in that the energy shielding layer comprises a patterned reflective mask layer (3).

3. A record carrier as claimed in claim 2, characterized in that the patterned reflective mask layer (3) comprises a material with a relatively high thermal conductivity.

4. A record carrier as claimed in claim 2, characterized in that the patterned reflective mask layer (3) comprises a metal or a metal alloy, preferably comprising aluminum silver, gold or copper.

5. A record carrier as claimed in claim 1, characterized in that the energy shielding layer comprises a switchable mask layer (13).

6. A record carrier as claimed in claim 5, characterized in that the switchable mask layer (13) is substantially transparent during the retrieval of information from the active layer (2).

7. A record carrier as claimed in claim 5, characterized in that the switchable mask layer (13) comprises a thermo-chromic layer.

8. A record carrier as claimed in claim 7, characterized in that the thermo-chromic layer comprises pure elongated pi-conjugated oligomers or polymers of pi-conjugated materials in a solid, semi-solid, or gel-type matrix of organic, preferably polymeric, inorganic or organic-inorganic hybrid nature, in particular having a concentration of pi-conjugated material between 1 and 100%.

9. A record carrier as claimed in claim 7, characterized in that the thermo-chromic layer comprises pH-sensitive dye molecules and colour developers.

10. A record carrier as claimed in claim 7, characterized in that the thermo-chromic layer comprises a dye material in which the dye molecules are aggregated, in particular forming J-type aggregates or H-type aggregates.

11. A record carrier as claimed in claim 5, characterized in that the switchable mask layer (13) comprises a liquid crystalline material, preferably a chiral nematic or a cholesteric liquid crystalline material.

12. A record carrier as claimed in claim 1, characterized in that the energy shielding layer comprises a patterned reflective mask layer (3) and a switchable mask layer (13).
